(19) United States
(12) Patent Application Publication
(10) Pub. No.: US 2012/0124775 A1
(43) Pub. Date: May 24, 2012

(54) FRICTION HINGE WITH CLOSED CLIPS

(76) Inventors: Victor A. CECI, Greenwich, CT (US); Raymond F. Augustine, JR., Greenwich, CT (US); Douglas Collins, Trumbull, CT (US)

(21) Appl. No.: 12/950,022

(22) Filed: Nov. 19, 2010

(51) Int. Cl. E05D 11/08

(52) U.S. Cl. 16/342

(57) ABSTRACT

A hinge for coupling two parts to allow one part to be positioned at an arbitrary angle and to maintain said angle by providing a high static torque that resists rotation between the parts. The hinge includes a plurality of identical clips having a flat polygonal shape and a closed opening a receiving a cylindrical shaft. The clips are stacked to form a central opening having a polygonal shape and the shaft extends through the central opening to form an interference fit with the clips.

### RELATED APPLICATIONS

None

### BACKGROUND TO THE INVENTION

1. Field of Invention

This invention pertains to a friction hinge connecting two parts, the hinge member including a cylindrical shaft and one or more closed clips in frictional engagement with the shaft and being engaged to part.

2. Description of the Prior Art

Friction hinges are used for many rotatable mounting applications in which the maintenance of angular orientation is important. Electronic displays are among the major applications.

In keeping with today's miniaturization of electronics, manufacturers of friction hinges are continually pressed to produce hinges that are smaller, higher in torque and, of course, less costly. Having long ago exceeded the pressure capabilities of other low-cost materials, friction hinges for applications demanding high torque density employ the frictional characteristics of steel-on-steel, the usual configuration being some form of steel band forced against a steel shaft with a perilously thin and easily displaced barrier of lubrication between them.

One common configuration has a steel band generally in the shape of a question mark that is disposed about a hardened steel shaft. The leg of the question mark, called the tail, extends more or less radially away from the shaft and is so arranged that movement of the hinge produces a force perpendicular to the tail. In one direction such a force tightens the band around the shaft producing a torque related to the wrap angle of the band around the shaft in accordance with the well known principles of wrap spring devices. In the other direction the band is loosened, producing a lower torque. (In the present application, reference is made to torques between the various parts of a hinge. This terminology refers to the torque being applied to the hinge in order to overcome static fiction and cause rotation).

For motion in the high-torque direction, because the band tightens exponentially with the angle of wrap, almost all of the torque results from pressure between the shaft and that part of the band nearest the tail that contacts the shaft. The rest of the band only performs the function of tensioning the thin region in which the high torque is produced. Since the pressure increases toward the high torque region, lubrication between the shaft and the band is squeezed away from that area. U.S. Pat. No. 5,491,874 reveals a band having grooves along that inner surface to spread the high pressure and to act as reservoirs for lubrication.

Another configuration is revealed in U.S. Pat. No. 5,697,125. This configuration provides similar torque for both directions of shaft rotation. Having a smaller angle of wrap than the question mark band, the wrap-down torque would be lower. But that loss can be offset by using more bands which can also be thicker. The torque comes both from bending moment in the bands and from the wrap-down effect.

Still another method for achieving rotational torque is revealed in U.S. Pat. No. 7,143,476 in which Belleville washers are compressed against plates to provide surface friction under rotation. The operation is much like that of a bicycle coaster brake.

The working life of steel-on-steel friction hinges depends on a number of different factors that have to be carefully controlled to achieve high life-cycle counts. The hardness of the shaft surface and of the bands must each be correct. Surface finish and preparation are also important. A lubricant must be chosen that can withstand the high pressures involved. And great care must be taken with the geometry so that the high pressures are distributed as evenly as possible over the largest area.

Lubrication is an issue because the operation of the hinge tends to force the lubricant out of the hinge. And lubricants are unwelcome in the electronic environment and they are often harmful to plastics.

Hinge failures are characterized by uneven or markedly varying torque during rotation, a rough feel as the hinge is rotated, or breakage of a hinge with the stress fracture of a component. Analysis of failed hinges often reveals inadequate lubrication resulting in galling of the shaft and band.

Having a larger area for friction means that a longer working life can be reached. Increased storage capacity for lubricant also leads to extended life. The ability of the hinge to redistribute its lubricant and to recoat the frictional surfaces is a key to long operational life. Our inventive hinge provides all of these advantages in a configuration that can be smaller than prior art hinges of comparable torque. We refer to hinges with this characteristic as ones having a high torque density

### SUMMARY OF THE INVENTION

Briefly, according to this invention, a hinge is provided for interconnecting two parts to positioned one part at an arbitrary angle with respect to another part. The hinge includes a plurality of clips associated with one of the parts, each clip having a clip body with a flat shape formed of an opening with a plurality of continuous segments or sides surrounding said opening. The clips are arranged in a stack with said sides being disposed in an overlapping relationship and said openings forming a continuous hole with a uniform cross section and extending through said stack along the axis of the hole. A cylindrical shaft extends coaxially through said central hole and cooperates with the clips to form an interference fit resistant to a high torque. Preferably, the clips and the openings have the shape of a regular polygon, such as an equilateral triangle.

In one embodiment, the clips include mounting extensions for mounting to one of the parts. Alternatively, a separate mounting element is provided that engages the clips and is used to mount the hinge to a part.

### BRIEF DESCRIPTION OF THE DRAWINGS

FIG. 1 shows an assembly of a display mounted on a rack using compact, high-torque hinges constructed in accordance with this invention;

FIG. 2 is a partially exploded view of the assembly of FIG. 1;

FIG. 3 is an exploded view of the hinges of FIGS. 1 and 2.

FIG. 4a depicts an alternative embodiment of hinge of our invention having multiple clips attached to a mounting housing;

FIG. 4b is an exploded view of the hinge of FIG. 4.

FIG. 5 shows an alternate embodiment with arcuate cut-outs;

FIG. 6 is a perspective view of another embodiment with a clip employed in a hinge having detent positions.

FIG. 7 shows an alternative embodiment with the clips having integral mounting means;

FIG. 8 shows yet another embodiment with the clips having a different mounting means;

FIG. 9 is a perspective view of a clip having a pentagonal opening.

### DETAILED DESCRIPTION OF THE INVENTION

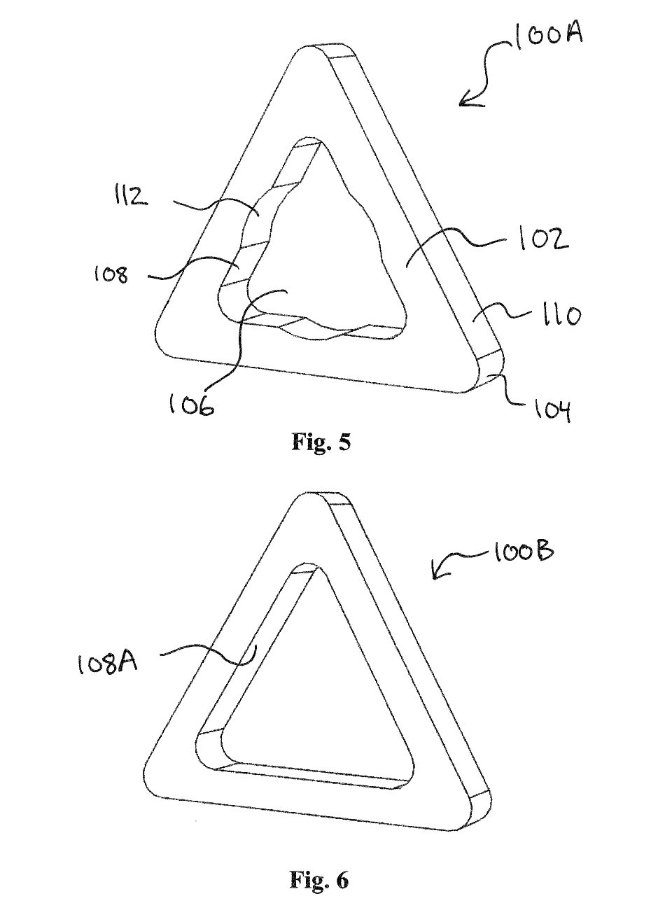

A friction hinge constructed in accordance with this invention includes a plurality of clips of a suitable material, usually spring steel, each clip having an opening receiving a cylindrical shaft. As best seen in FIGS. 5 and 6, each clip 100 includes a flat body having a triangular shape with three equal sides or segments 102 and, optionally, somewhat rounded apexes 104. A substantially triangular opening 106 is disposed centrally within the body and is oriented so that the sides 102 formed between the inner walls 108 of opening 106 and the respective outer walls 110 of the body have a substantially constant width. In other words, the opening 106 is formed with inner walls 108 that are parallel to the outer walls 110.

In the embodiment of FIG. 5, the inner walls 108 are formed with a scallop or curved indentation 112. Preferably, the scallop 112 has a radius of curvature that is equal to or slightly larger than the radius of the shaft received in the aperture 106 as described below. In the embodiment of FIG. 6, clip 100B has inner walls 108A that are straight.

The body is preferably stamped from a sheet of spring steel, and then subjected to heat treatment, deburring, and other surface treatments. Typically, the body has a thickness in the range of 0.025 to 0.050 inches, depending upon the torque requirements and the space available. Whatever the thickness, care must be taken in stamping to ensure a uniform inner surface that is perpendicular to the starting flat surface of the material. As discussed in more details below, in some embodiments, the clips are triangular, as shown in FIG. 5, 6, or have other, preferably regular polygonal shapes.

For some applications, other polygonal shapes of the openings may also be useful. If the shaft has a flat surface axially oriented along one or more portions of its perimeter, detenting is provided as the flat surface becomes aligned with a side of the polygonal opening. The number of sides will then determine the number and angular displacement of the detent positions. Where detenting is required, the sides of the polygonal openings would not have arcuate cut-outs unless the shaft were also to have that shape ground along its surface.

Absent specific situations having certain angular operational requirements, triangular clip openings are preferred because that will result in more even loading of the shaft. If the openings have an even number of sides, then there will be a tendency for one pair of opposing sides to bear more heavily on the shaft than the others. And, as will be seen below, a pentagonal opening will usually result in two of the sides being more lightly loaded.

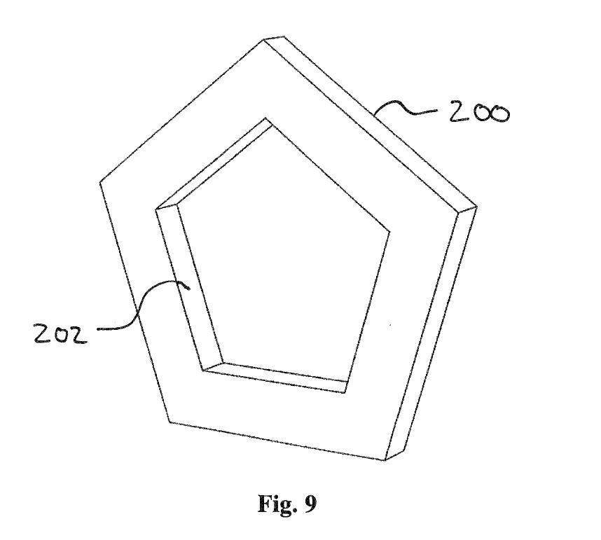

FIG. 9 shows a pentagonal clip 200 with straight side surfaces 202. Polygonal clips with more than three sides may be useful for designs that require detents at angles smaller than 120 degrees. However, as mentioned earlier, the difficulty that arises is that, to keep relatively equal pressures on each of the sides requires clips that are manufactured to very close tolerances. Tolerance requirements on triangular clips are not so severe.

In some embodiments, the clips are constructed to provide the mountings for the hinge. The mounting can be of any convenient shape, including bends and twists or other features which might be needed. Where an extended clip is used, there is an opening cut in the material parallel to the side of the triangle so as to create, for that side, the same beam thickness as have the other sides. This cut is to cause the bending characteristics of the three sides of the triangle to be essentially the same.

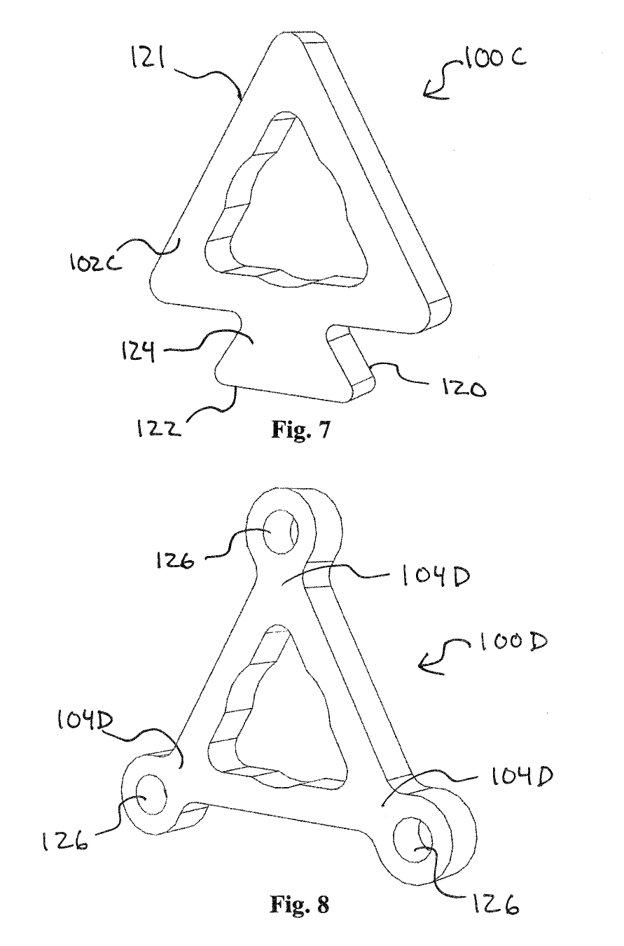

More specifically, the clips have a main portion which has the shape shown in FIGS. 5, 6, 9, etc., and an extension which may or may not be coplanar with the main body and is used as a mounting means for mounting the clips. In FIG. 7, for example, a clip 100C is shown having at least one extension 120 that is coplanar with triangular main body portion 121 and is attached at the center of one of the sides 102C. Preferably extension 120 has a trapezoidal shape with a base 122 spaced from the side 102C that is wider than the zone 124 where the extension 120 is attached to side 102C. The extension 120 can then be inserted into a complementary groove (not shown) of part thereby mounting the clip 100C.

In the embodiment shown in FIG. 8, a clip 100D is shown in which at least, one or more apexes 104D are provided with eyelets 126 through which an appropriate screw or other attaching means can be inserted to mount the clip 100D.

Preferably, in each hinge, several clips having the same shape and dimensions (or at least the same sized and shaped main bodies) are stacked together with their sides, apexes and openings aligned.

The other part of the hinge is a shaft made of hardened steel and inserted through the aligned openings of the stack of clips.

Inserting the shaft requires some force since the diameter of the shaft is such that it is an interference fit into the triangular openings in the clips and results in bending of the sides of the clips slightly. The amount of interference and the number of clips determine the torque required to rotate the shaft within the stack of clips.

Three sided clips are preferred for a friction hinge whose torque is to be constant under rotation because, for a given size hinge, triangles provide the longest beam length. This allows more predictable control of the torque characteristics of the hinge.

To increase the surface area over which the torque is produced (e.g., to increase the interference fit), arcuate segments may be formed in each side of the opening in the form, such as the scallops 112 in FIG. 5. Preferably the segments are positioned to define the contact zone with the shaft along each side of the opening.

As mentioned above, in some embodiments, the clips are held in a housing for mounting. Such a housing may be useful for better containment of a lubricant provided at the interference zones between the clips and the shaft.

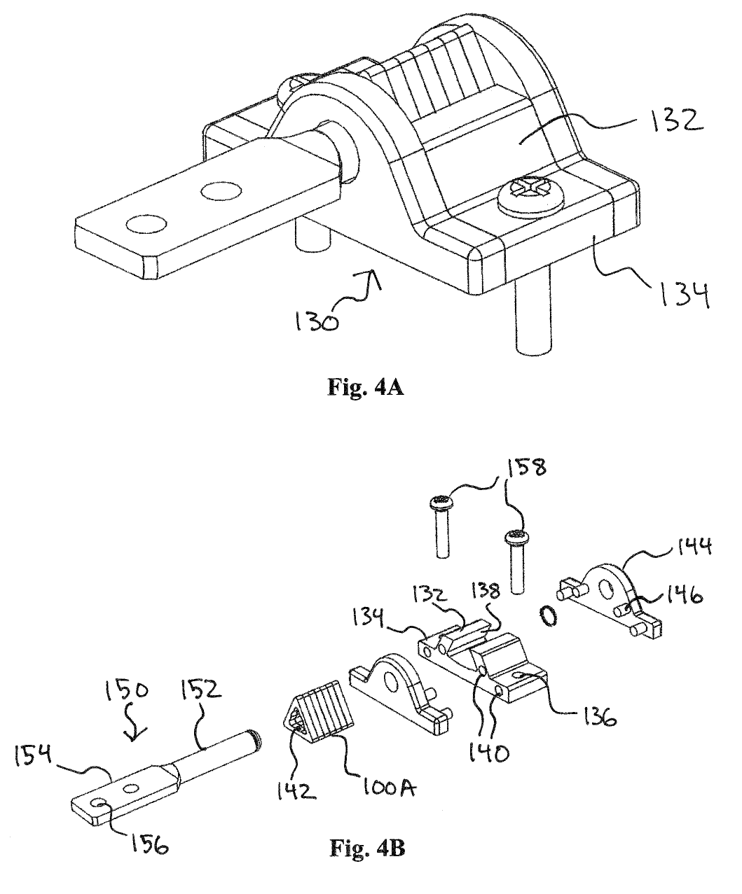

The embodiment shown in FIGS. 4a and 4b illustrate some implementations of the latter features. In these figures, hinge 130 includes a housing 132 with two wings 134 having mounting holes 136. The housing is formed with a trapezoidal groove 138 and several lateral holes 140.

The hinge 130 further includes several (e.g., 6-15) clips 100A constructed as shown in FIG. 5 aligned so that their openings form a single triangular hole 142. The hinge further includes two end caps 144 with bosses 146 that fit into holes 140. The groove 138 is sized and shaped to receive the bottom portion of the stack of clips 100A. Once the stack of clips is inserted into the groove 138, the end caps are attached to the body 132 with the bosses 146 being received in holes 140.

The other part of the hinge 130 is shaft 150 that includes a cylindrical section 152 sized and shaped to form an interference fit with the clips 100A as described, and a flat section 154 with holes 156. Once the hinge 130 is assembled, as shown in FIG. 4a, the housing 132 can be attached to one part (not shown) by screws 158 passing through holes 136 and the shaft 150 is attached to another part, for example via flat section 154 and its holes 156.

The difficulty of storing and retaining lubrication within the hinge has been a major limitation on the cycle life of prior-art hinges. Our inventive hinge provides large spaces within the corners of each clip for the storage of lubricants. The normal operation of the hinge recoats the frictional surfaces.

An additional advantage of our hinge design is that clips can easily be added to increase the torque of the hinge. The hinge is capable of very high torque densities.

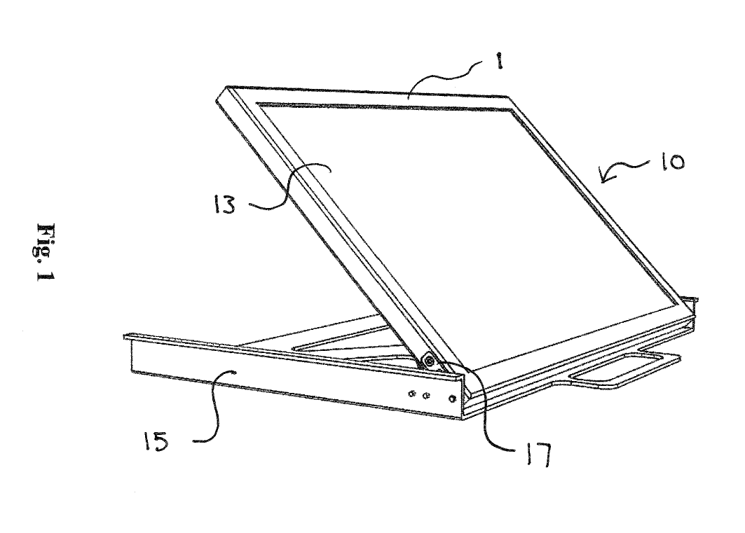

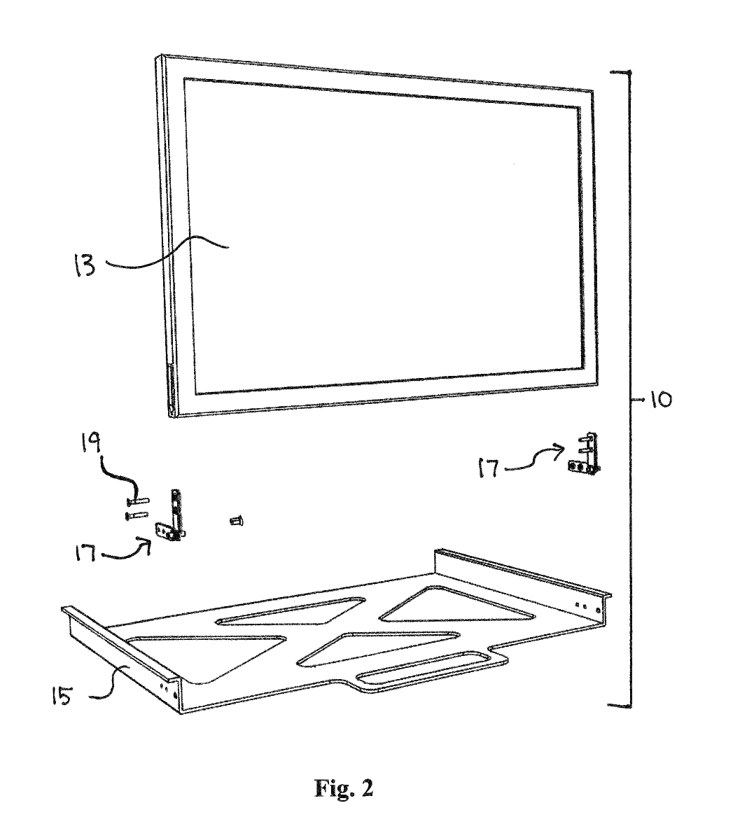

FIGS. 1 and 2 shows a typical assembly, such as a rack mounted display or screen by hinges constructed in accordance with this invention. Assembly 10 includes a screen 13 and a rack 15. The screen 13 is attached to the rack 15 by hinges 17.

The screens in such installations are often large and heavy and require substantial torque to maintain any arbitrary viewing position desired by the user. Moreover, often need to fold them down so that they rest on top of the rack when not in use and then pivoted back to any arbitrary angle. Once the screen is pivoted to a particular angle, and released, it must maintain its position without any drift or shake for as long as necessary.

The hinges 17 are attached by screws 19 or other suitable fastening means attaching the hinges to both the screen 13 and the rack 15.

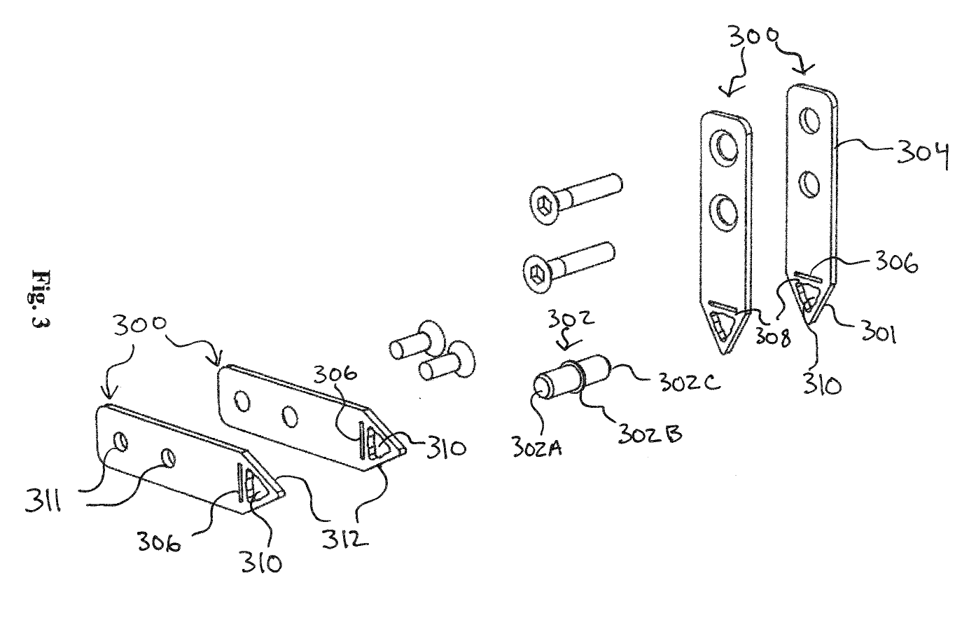

Because of the specific geometric configuration of the screen 13 and rack 15, in the embodiment of FIGS. 1-3, clips are used to mount the hinge to both of these parts. FIG. 3 shows details of the hinges 17. Each hinge includes a plurality of clips 300 and a shaft 302. In this embodiment, clips 300 are punched out of steel strips of sufficient length. In a particular situation, the appropriate number of clips is chosen, as required, to support the actual load. A significant advantage of our invention is that the number of clips can easily be varied without making a large change in the space occupied by the hinge. Each clip 300 includes a main body 301 having the same shape as the clip shown in FIG. 5 with scallops similar to scallops 112. Attached to the main body 301 there is provided an extension 304 with the mounting holes 311. Importantly, a cut out 306 is formed at the interface between the body 301 and extension 304. This cut out allows the segment 308 of body 301 between the cut out 306 and the central hole 310 to flex outwardly and axially with respect to hole 310 when shaft 302 is inserted into the hole 310, in the same manner as the sides 102 for the embodiment of FIG. 5. Preferably, cut out 306 is placed at a distance from the hole 310 that is substantially equal to the width of the clip segments 312.

Shaft 302 has two cylindrical surfaces 302A, 302C separated by a circumferential shoulder 302B which has a larger diameter. The surfaces 302A, 302C are sized to form the interference fit within the triangular holes 310 of clips 300. Chamfers on the ends of shaft 302 are helpful in assembling the hinge to prevent damage to the clips as the shaft is forced into the central holes 310. Shoulder 3028 keeps shaft 302 centered. In the apparatus schematically shown in FIG. 1, screen 1 is held in lateral position by frame 15. So, once assembled, there would not be sufficient clearance for either hinge, in use, to move laterally far enough for the hinge 300 to come apart. But in applications lacking such constraint, lock rings, snap rings, or other appropriate means can be added to the shafts to keep the hinges together.

In accordance with principles well know in the art of friction hinges, the hardness of contacting surfaces at which friction is to be produced should differ in hardness. In our invention, the shafts are harder than the clips by several Rockwell points.

In the embodiment of FIGS. 1-3, a first set of clips 300 are attached by screws 19 to the screen 13 and another set of clips 300 (preferably the same number as in the first set) are attached to the rack 15. In another embodiment (not shown), the clips may be intermeshed.

As illustrated in the drawings and the description above, the hinges can be used in a number of different configurations to rotatably connect two different parts. In one configuration, one set of clips is attached to one part, another set of clips is connected to the second part and one or both sets of clips are rotatable with respect to the shaft engaging the clips through their central openings. In another configuration (e.g., FIGS. 4a and 4b) all the clips are mounted or otherwise secured to one part and the shaft is secured to the second part.

In all the embodiments described, each clip is best described as having at least a flat clip body formed of a plurality of sides or segments (102 in FIG. 5) disposed to form a hole 104, said sides or segments 102 have substantially identical shapes. Preferably, the width of the sides or segments does not exceed the diameter of the shaft 302.

The clips are preferably made of steel spring as described, but could also be made of other materials such as various plastic materials, including a self-lubricating plastic material. The clips are arranged or stacked over each other with said openings being aligned to form a central hole along a longitudinal axis through the stack with an essentially constant cross sectional shape. As the shaft is inserted into the stack, an interference fit is formed between the shaft and the stack of clips that resists rotation due to a high static force generated by the interference fit. The shaft and the stack are shaped to resist a very high static torque. For example, a hinge formed of 3 clips having a thickness of 0.050 inches, a shaft with a diameter of 3/16 inches and an interference of 0.003 inches produced a static torque in the range of 19 in-pounds.

Numerous modifications may be made to the invention without departing from its scope as defined in the appended claims.

We claim:

1. A hinge interconnecting two parts to positioned one part at an arbitrary angle with respect to another part, said hinge comprising:
a plurality of clips associated with one of the parts, each clip having a clip body having a flat shape formed of an opening with a plurality of segments surrounding said opening, said clips being arranged in a stack with said sides being disposed in an overlapping relationship and said openings forming a continuous hole with a uniform cross section and extending through said stack along a hole axis; and
a cylindrical shaft extending coaxially through said central hole;
said shaft and said clips cooperating to form an interference fit resistant to a high torque.

2. The hinge of claim 1 wherein said clips and said openings have the shape of a regular polygon.

3. The hinge of claim 2 wherein said clips and said opening have the shape of an equilateral triangle.

4. The hinge of claim 1 wherein a first set of said clips is mounted on a first part and a second set of said clips is mounted on said other part.

5. The hinge of claim 1 wherein said clips having clip bodies further comprising a mounting section attaching said clips to one of said first and second parts.

6. The hinge of claim 1 wherein said sides have a constant width.

7. The hinge of claim 6 wherein said shaft has a shaft diameter that is no larger then said constant width.

8. A hinge comprising:
a plurality of clips, each hinge including a clip body having a flat shape formed from a plurality of continuous segments disposed end to end to define a regular polygon with an opening having a polygonal shape, said clips being stacked to form a hole having said polygonal shape extending along a longitudinal axis; and
a shaft having a cylindrical shape and being disposed coaxially within said hole, said shaft and clips being sized and shaped to form an interference therebetween, said interference fit generating a resistant torque to resist rotation of said clips with respect to said shaft.

9. The hinge of claim 8 wherein said hole and said clips have the same shape.

10. The hinge of claim 9 wherein said clips and hole have the shape of a regular polygon.

11. The hinge of claim 10 wherein said clips and hole have the shape of an equilateral triangle.

12. The hinge of claim 8 wherein each of said segments has an inner side defining said hole, said side being formed with an arcuate indentation.

13. The hinge of claim 12 wherein in said indentation has an indentation radius approximately equal to the radius of said shaft.

14. The hinge of claim 8 wherein clip body further includes a clip extension for mounting said clips.

15. The hinge of claim 14 wherein said clip body includes an elongated clip hole at a predetermined distance from said opening.

16. The hinge of claim 8 further comprising a mounting member engaging said clips and being shaped and sized to attach said clips to one of said parts.

17. The hinge of claim 16 wherein said mounting member includes a mounting body formed with a slot shaped and sized to receive said stack of clips.

18. The hinge of claim 8 wherein said clips and shaft are made of spring steel.

19. The hinge of claim 8 wherein said clips and shaft are made of a plastic material.
